(19) United States
(12) Patent Application Publication
(10) Pub. No.: US 2005/0210304 A1
(43) Pub. Date: Sep. 22, 2005

(54) Method and apparatus for power-efficient high-capacity scalable storage system

(75) Inventors: Steven Fredrick Hartung, Boulder, CO (US); Aloke Guha, Louisville, CO (US)

Correspondence Address: CARPENTER & KULAS, LLP, 1900 EMBARCADERO ROAD, SUITE 109, PALO ALTO, CA, 94303, US

(73) Assignee: Copan Systems, Longmont, CO (US)

(21) Appl. No.: 11/076,447

(22) Filed: Mar. 8, 2005

Related U.S. Application Data
(63) Continuation-in-part of application No. 10/607,932, filed on Jun. 26, 2003.

(51) Int. Cl. G06F 1/28; G06F 1/26

(52) U.S. Cl. 713/320; 713/300

(57) ABSTRACT

A method for managing power consumption among a plurality of storage devices is disclosed. A system and a computer program product for managing power consumption among a plurality of storage devices are also disclosed. All the storage devices from among the plurality of storage devices are not powered-on at the same time. A request is received for powering on a storage device. A priority level for the request is determined, and a future power consumption (FPC) of the plurality of storage devices is predicted. The FPC is compared with a threshold. If the threshold is exceeded, a signal is sent to power off a powered-on device. The signal is sent only when the powered-on device is being used for a request with a lower priority than the determined priority. Once, the powered-on device is powered off, the requested storage device is powered on.

### CROSS-REFERENCE TO RELATED APPLICATION

This application is a continuation-in-part of the following application, which is hereby incorporated by reference, as if it is set forth in full in this specification:
U.S. patent application Ser. No. 10/607,932, entitled ‘Method and Apparatus for Power-Efficient High-Capacity Scalable Storage System’, filed on Jun. 26, 2003.

This application is related to the following application, which is hereby incorporated by reference, as if it is set forth in full in this specification:
Co-pending U.S. patent application Ser. No. 10/996,086, ‘Method and System for Accessing a Plurality of Storage Devices’, filed on Nov. 22, 2004.

### BACKGROUND

The present invention relates generally to data storage systems. More specifically, the present invention relates to power-efficient high-capacity storage systems that are scalable and reliable.

Storing large volumes of data with high throughput in a single system requires the use of large-scale and high-capacity storage systems. In such a system, a large number of disk drives are closely packed. The closed packed structure of the disk drives in the system results in problems such as excessive heating of the drives, decreased drive lives, disk failures, degradation in data integrity, increased power supply costs, and power distribution problems. These problems are alleviated by turning off drives that are not needed, or are not expected to be needed in the near future. However, a large number of operations are performed by the system. These operations include user made input/output requests and tasks internal to the system. Tasks internal to the system include maintenance of disk drives and data redundancy. It is difficult to perform such a large number of operations with high speed in a storage system where there is a limit on the number of disk drives that are powered on. Moreover, there may be simultaneous requests for different types of operations.

### SUMMARY

In accordance with one embodiment of the present invention, a method for managing power consumption among a plurality of storage devices is provided, where all the storage devices are not powered on at the same time. The method comprises receiving a request for powering on a requested storage device. A priority level for the request is determined and a future power consumption (FPC) for the plurality of storage devices is predicted. The FPC is predicted by adding a current total power consumption of the plurality of storage devices to an anticipated power consumption of the requested storage device. The FPC is compared with a predetermined threshold. If the FPC is found to be greater than the threshold, a signal is sent to power off a powered-on device. This happens when the powered-on device is used for carrying out a request with a priority level below the determined priority level.

Various embodiments of the present invention provide priority based power management of a plurality of storage devices such as disk drives. Different types of drive accesses are required for the requests. Each type of drive access is assigned a priority level, according to which the drives are powered on or off.

In one embodiment the invention provides a method for managing power consumption among a plurality of storage devices wherein less than all of the plurality of storage devices are powered-on at the same time, the method comprising: receiving a request for powering-on a requested storage device; determining a priority level for the request; predicting a future power consumption by adding a current total power consumption of the plurality of storage devices to the anticipated power consumption of the requested storage device; comparing the future power consumption against a predetermined threshold; and if the future power consumption is greater than the threshold then sending a signal to power-off a powered-on device used for a request having a priority level below the determined priority level.

In another embodiment the invention provides an apparatus for managing power consumption among a plurality of storage devices wherein less than all of the plurality of storage devices are powered-on at the same time, the apparatus comprising: a host command interface for receiving a request for powering-on a requested storage device; a power budget manager for determining a priority level for the request and for predicting a future power consumption by adding a current total power consumption of the plurality of storage devices to the anticipated power consumption of the requested storage device, wherein the power budget manager compares the future power consumption against a power budget; and if the future power consumption is greater than the power budget the power budget manager sends a signal to power-off a powered-on device used for a request having a priority level below the determined priority level.

In another embodiment the invention provides a computer-readable medium including instructions executable by a processor for managing power consumption among a plurality of storage devices wherein less than all of the plurality of storage devices are powered-on at the same time, the computer-readable medium comprising: one or more instructions for receiving a request for powering-on a requested storage device; one or more instructions for determining a priority level for the request; one or more instructions for predicting a future power consumption by adding a current total power consumption of the plurality of storage devices to the anticipated power consumption of the requested storage device; one or more instructions for comparing the future power consumption against a predetermined threshold; and if the future power consumption is greater than the threshold then sending a signal to power-off a powered-on device used for a request having a priority level below the determined priority level.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 is a diagram illustrating the general structure of a multiple-disk data storage system in accordance with one embodiment.

FIGS. 2A and 2B are diagrams illustrating the interconnections between the controllers and disk drives in a densely packed data storage system in accordance with one embodiment.

FIG. 3 is a diagram illustrating the physical configuration of a densely packed data storage system in accordance with one embodiment.

FIG. 4 is a flow diagram illustrating the manner in which the power management scheme of a densely packed data storage system is determined in accordance with one embodiment.

FIG. 5 is a diagram illustrating the manner in which information is written to a parity disk and the manner in which disk drives are powered on and off in accordance with one embodiment.

FIG. 6 is a diagram illustrating the content of a metadata disk in accordance with one embodiment.

FIG. 7 is a diagram illustrating the structure of information stored on a metadata disk in accordance with one embodiment.

FIG. 8 is a diagram illustrating the manner in which containers of data are arranged on a set of disk drives in accordance with one embodiment.

FIG. 9 is a diagram illustrating the manner in which the initial segments of data from a plurality of disk drives are stored on a metadata volume in accordance with one embodiment.

FIG. 10 is a diagram illustrating the use of a pair of redundant disk drives and corresponding parity and metadata volumes in accordance with one embodiment.

FIG. 11 is a diagram illustrating the use of a data storage system as a backup target for the primary storage via a direct connection and as a media (backup) server to a tape library in accordance with one embodiment.

FIG. 12 is a diagram illustrating the interconnect from the host (server or end user) to the end disk drives in accordance with one embodiment.

FIG. 13 is a diagram illustrating the interconnection of a channel controller with multiple stick controllers in accordance with one embodiment.

FIG. 14 is a diagram illustrating the interconnection of the outputs of a SATA channel controller with corresponding stick controller data/command router devices in accordance with one embodiment.

FIG. 15 is a diagram illustrating the implementation of a rack controller in accordance with one embodiment.

FIG. 16 is a block diagram illustrating a system suitable for data storage, in accordance with an exemplary embodiment of the present invention.

FIG. 17 is a block diagram illustrating a MAID system.

FIG. 18 is a flowchart depicting a method for managing a plurality of disk drives, in accordance with an embodiment of the present invention.

FIG. 19 is a diagram illustrating software modules in the MAID system.

FIG. 20 is a block diagram illustrating components of software modules in the MAID system.

FIG. 21 is a block diagram illustrating an exemplary hierarchy of priority levels, in accordance with an exemplary embodiment of the present invention.

### DESCRIPTION OF THE VARIOUS EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for providing scalable, reliable, power-efficient, high-capacity data storage, wherein data storage drives are individually powered on and off, depending upon their usage requirements.

In one embodiment, the invention is implemented in a RAID-type data storage system. This system employs a large number of hard disk drives. When data is written to the system, the data is written to one or more of the disk drives. Metadata and parity information corresponding to the data are also written to one or more of the disk drives to reduce the possibility of data being lost or corrupted. The manner in which data is written to the disks typically involves only one data disk at a time, in addition to metadata and parity disks. Similarly, reads of data typically only involve one data disk at a time. Consequently, data disks which are not currently being accessed can be powered down. The system is therefore configured to individually control the power to each of the disks so that it can power up the subset of disks that are currently being accessed, while powering down the subset of disks that are not being accessed.

Because only a portion of the disk drives in the system are powered on at any given time, the power consumption of a power managed system can be less than a non-power managed system. As a result of the lower power consumption of the system, it generates less heat, requires less cooling and can be packaged in a smaller enclosure. In a system where most of the disk drives are powered down at any given time the data can be distributed by a simple fan-out interconnection which consumes less power and takes up less volume within the system enclosure than other approaches to data distribution. Yet another difference between the present system and conventional systems is that, given a particular reliability (e.g., mean time to failure, or MTTF) of the individual disk drives, the present system can be designed to meet a particular reliability level (e.g., threshold mean time between failures, MTBF.

The various embodiments of the invention may provide advantages in the four areas discussed above: power management; data protection; physical packaging; and storage transaction performance. These advantages are described below with respect to the different areas of impact.

Power Management

In regard to power management, embodiments of the present invention may not only decrease power consumption, but also increase system reliability by optimally power cycling the drives. In other words, only a subset of the total number of drives is powered on at any time. Consequently, the overall system reliability can be designed to be above a certain acceptable threshold.

The power cycling of the drives on an individual basis is one feature that distinguishes the present embodiments from conventional systems. As noted above, prior art multi-drive systems do not allow individual drives, or even sets of drives to be powered off in a deterministic manner during operation of the system to conserve energy. Instead, they teach the powering off of entire systems opportunistically. In other words, if it is expected that the system will not be used at all, the entire system can be powered down. During the period in which the system is powered off, of course, it is not available for use. By powering off individual drives while other drives in the system remain powered on, embodiments of the present invention provide power-efficient systems for data storage and enable such features as the use of closely packed drives to achieve higher drive density than conventional systems in the same footprint.

Data Protection

In regard to data protection, it is desirable to provide a data protection scheme that assures efficiency in storage overhead used while allowing failed disks to be replaced without significant disruption during replacement. This scheme must be optimized with respect to the power cycling of drives since RAID schemes will have to work with the correct subset of drives that are powered on at any time. Thus, any Read or Write operations must be completed in expected time even when a fixed set of drives are powered on. Because embodiments of the present invention employ a data protection scheme that does not use most or all of the data disks simultaneously, the drives that are powered off can be easily replaced without significantly disrupting operations.

Physical Packaging

In regard to the physical packaging of the system, most storage devices must conform to a specific volumetric constraint. For example, there are dimensional and weight limits that correspond to a standard rack, and many customers may have to use systems that fall within these limits. The embodiments of the present invention use high density packing and interconnection of drives to optimize the physical organization of the drives and achieve the largest number of drives possible within these constraints.

Storage Transaction Performance

In regard to storage transaction performance, the power cycling of drives results in a limited number of drives being powered on at any time. This affects performance in two areas. First, the total I/O is bound by the number of powered drives. Second, a random Read operation to a block in a powered down drive would incur a very large penalty in the spin-up time. The embodiments of the present invention use large numbers of individual drives, so that the number of drives that are powered on, even though it will be only a fraction of the total number of drives, will allow the total I/O to be within specification. In regard to the spin-up delay, the data access scheme masks the delay so that the host system does not perceive the delay or experience a degradation in performance.

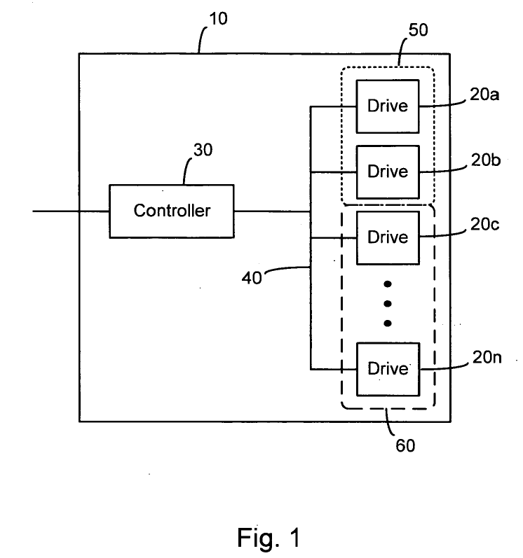

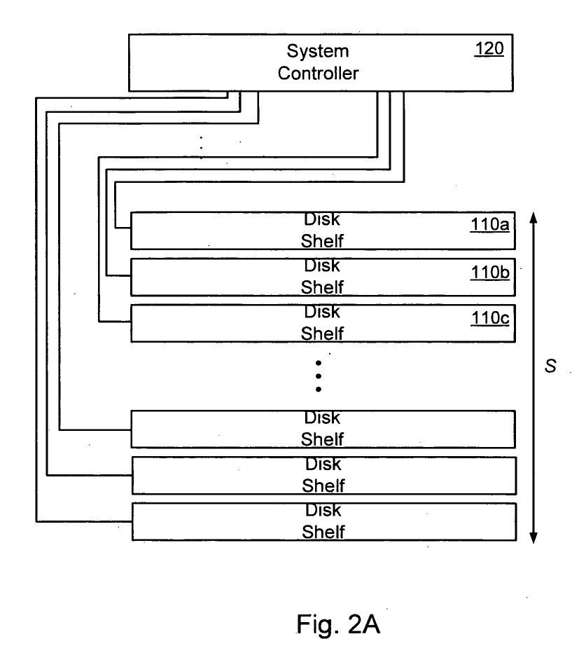

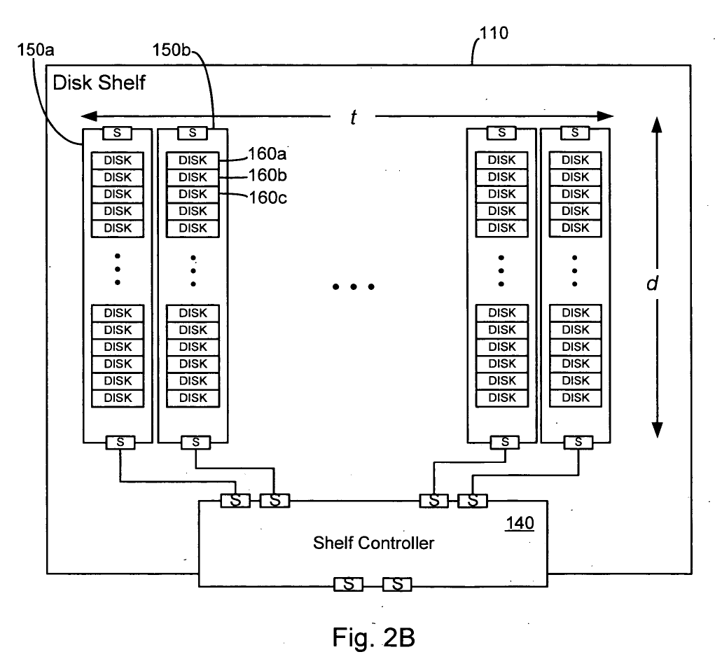

Referring to FIG. 1, a diagram illustrating the general structure of a multiple-disk data storage system in accordance with one embodiment of the invention is shown. It should be noted that the system illustrated in FIG. 1 is a very simplified structure which is intended merely to illustrate one aspect (power cycling) of an embodiment of the invention. A more detailed representation of a preferred embodiment is illustrated in FIG. 2 and the accompanying text below.

As depicted in FIG. 1, data storage system 10 includes multiple disk drives 20. It should be noted that, for the purposes of this disclosure, identical items in the figures may be indicated by identical reference numerals followed by a lowercase letter, e.g., 20a, 20b, and so on. The items may be collectively referred to herein simply by the reference numeral. Each of disk drives 20 is connected to a controller 30 via interconnect 40.

It can be seen in FIG. 1 that disk drives 20 are grouped into two subsets, 50 and 60. Subset 50 and subset 60 differ in that the disk drives in one of the subsets (e.g., 50) are powered on, while the disk drives in the other subset (e.g., 60) are powered down. The individual disk drives in the system are powered on (or powered up) only when needed. When they are not needed, they are powered off (powered down). Thus, the particular disk drives that make up each subset will change as required to enable data accesses (reads and writes) by one or more users. This is distinctive because, as noted above, conventional data storage (e.g., RAID) systems only provide power cycling of the entire set of disk drives—they do not allow the individual disk drives in the system to be powered up and down as needed.

As mentioned above, the system illustrated by FIG. 1 is used here simply to introduce the power cycling aspect of one embodiment of the invention. This and other embodiments described herein are exemplary and numerous variations on these embodiments may be possible. For example, while the embodiment of FIG. 1 utilizes multiple disk drives, other types of data storage, such as solid state memories, optical drives, or the like could also be used. It is also possible to use mixed media drives, although it is contemplated that this will not often be practical. References herein to disk drives or data storage drives should therefore be construed broadly to cover any type of data storage. Similarly, while the embodiment of FIG. 1 has two subsets of disk drives, one of which is powered on and one of which is powered off, other power states may also be possible. For instance, there may be various additional states of operation (e.g., standby) in which the disk drives may exist, each state having its own power consumption characteristics.

The powering of only a subset of the disk drives in the system enables the use of a greater number of drives within the same footprint as a system in which all of the drives are powered on at once. One embodiment of the invention therefore provides high density packing and interconnection of the disk drives. This system comprises a rack having multiple shelves, wherein each shelf contains multiple rows, or “sticks” of disk drives. The structure of this system is illustrated in FIG. 2.

Referring to FIG. 2, the top-level interconnection between the system controller 120 and the shelves 110 is shown on the left side of the figure. The shelf-level interconnection to each of the sticks 150 of disk drives 160 is shown on the right side of the figure. As shown on the left side of the figure, the system has multiple shelves 110, each of which is connected to a system controller 120. Each shelf has a shelf controller 140, which is connected, to the sticks 150 in the shelf. Each stick 150 is likewise connected to each of the disk drives 160 so that they can be individually controlled, both in terms of the data accesses to the disk drives and the powering on/off of the disk drives. The mechanism for determining the optimal packing and interconnection configuration of the drives in the system is described below.

It should be noted that, for the sake of clarity, not all of the identical items in FIG. 2 are individually identified by reference numbers. For example, only a few of the disk shelves (110a-110c), sticks (150a-150b) and disk drives (160a-160c) are numbered. This is not intended to distinguish the items having reference numbers from the identical items that do not have reference numbers.

Let the number of drives in the system be N, where N is a large number.

N is then decomposed into a 3-tuple, such that N=s.t.d where

s: number of shelf units in the system, typically determined by the physical height of the system. For example, for a 44U standard rack system, s can be chosen to be 8.

t: the number of “sticks” in the each shelf unit where a stick comprises a column of disks. For example, in a 24-inch-wide rack, t<=8.

d: the number of disk drives in each stick in a shelf. In a standard rack, d can be 14.

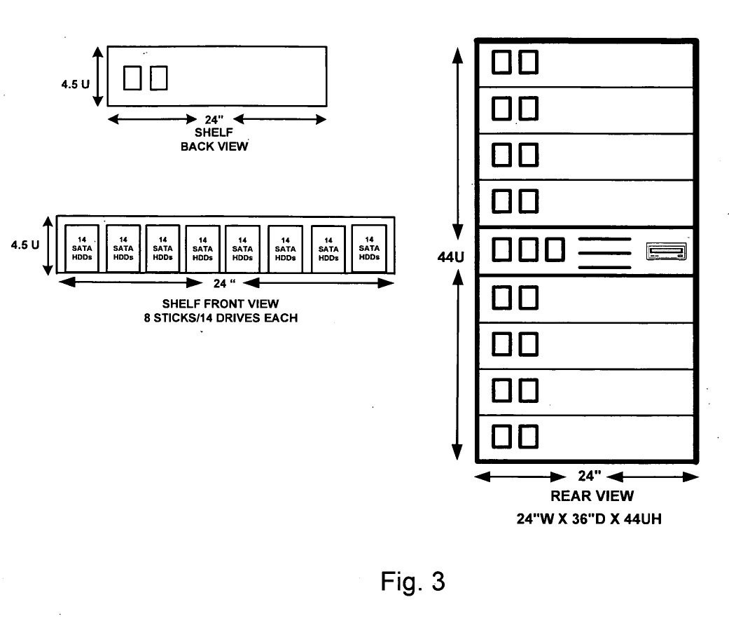

The configuration as shown in FIG. 2 is decomposed into shelves, sticks and disks so that the best close packing of disks can be achieved for purposes of maximum volumetric capacity of disk drives. One example of this is shown in FIG. 3. With the large racks that are available, nearly 1000 3.5″ disks can be packed into the rack.

The preferred configuration is determined by the decomposition of N into s, t and d while optimizing with respect to the i) volume constraints of the drives and the overall system (the rack), and ii) the weight constraint of the complete system. The latter constraints are imposed by the physical size and weight limits of standard rack sizes in data centers.

Besides constraints on weight and dimensions, large-scale packing of drives must also provide adequate airflow and heat dissipation to enable the disks to operate below a specified ambient temperature. This thermal dissipation limit also affects how the disks are arranged within the system.

One specific implementation that maximizes the density of drives while providing sufficient air flow for heat dissipation is the configuration shown in FIG. 3.

Power Cycling of Drives to Increase System Reliability and Serviceability

One embodiment of the invention comprises a bulk storage or near-online (NOL) system. This storage system is a rack-level disk system comprising multiple shelves. Hosts can connect to the storage system via Fibre Channel ports on the system level rack controller, which interconnects to the shelves in the rack. Each shelf has a local controller that controls all of the drives in the shelf. RAID functionality is supported within each shelf with enough drives for providing redundancy for parity protection as well as disk spares for replacing failed drives.

In this embodiment, the system is power cycled. More particularly, the individual drives are powered on or off to improve the system reliability over the entire (large) set of drives. Given current known annualized failure rates (AFRs), a set of 1000 ATA drives would be expected to have a MTBF of about 20 days. In an enterprise environment, a drive replacement period of 20 days to service the storage system is not acceptable. The present scheme for power cycling the individual drives effectively extends the real life of the drives significantly. However, such power cycling requires significant optimization for a number of reasons. For example, power cycling results in many contact start-stops (CSSs), and increasing CSSs reduces the total life of the drive. Also, having fewer powered drives makes it difficult to spread data across a large RAID set. Consequently, it may be difficult to implement data protection at a level equivalent to RAID 5. Still further, the effective system bandwidth is reduced when there are few powered drives.

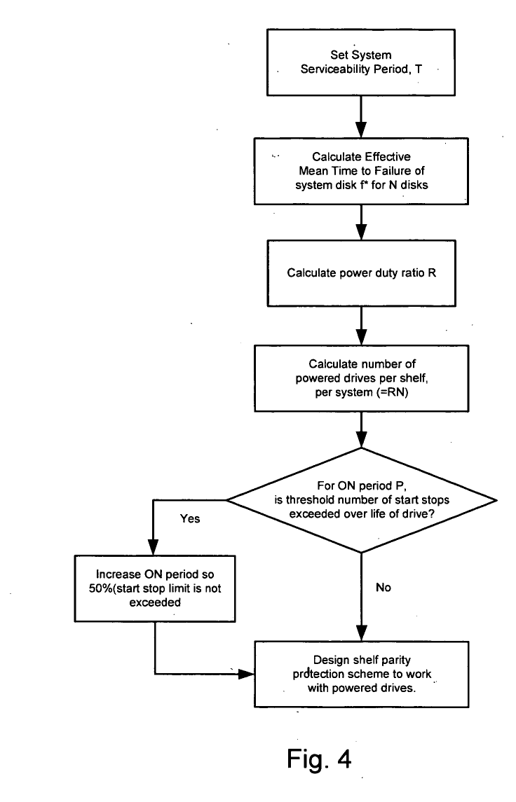

In one embodiment, the approach for determining the power cycling parameters is as shown in the flow diagram of FIG. 4 and as described below. It should be noted that the following description assumes that the disk drives have an exponential failure rate (i.e., the probability of failure is 1−e^{-λt}, where λ is the inverse of the failure rate). The failure rates of disk drives (or other types of drives) in other embodiments may have failure rates that are more closely approximated by other mathematical functions. For such systems, the calculations described below would use the alternative failure function instead of the present exponential function.

With a large number of drives, N, that are closely packed into a single physical system, the MTTF of the system will grow significantly as N grows to large numbers.

If the MTTF of a single drive is f (typically in hours) where f=1/(failure rate of a drive) then the system MTBF, F, between failures of individual disks in the system is
F=1/(1−(1−1/f)**N)

For N=1000, and f=500,000 hrs or 57 years, F=22 days. Such low MTBF is not acceptable for most data centers and enterprises. As mentioned above, the system MTBF can be increased by powering the drives on and off, i.e., power cycling the drives, to increase the overall life of each drives in the system. This facilitates maintenance of the system, since serviceability of computing systems in the enterprise requires deterministic and scheduled service times when components (drives) can be repaired or replaced. Since it is desired to have scheduled service at regular intervals, this constraint is incorporated into the calculations that follow.

Let the interval to service the system to replace failed disk drives be T, and required the power cycling duty ratio be R.

The effective system MTBF is T, and the effective failure rate of the system is 1/T.

Then, the effective MTBF in a system of N disks is:
f*=1/{1−(1−1/T)**1/N}

Thus, we can compute the effective MTTF of disks in a large number of drives in a single system so that the service interval is T.

Since the actual MTTF is f, the approach we take is to power cycle the drives, i.e., turn off the drives for a length of time and then turn them on for a certain length of time.

If R is the duty ratio to meet the effective MTTF, then
R=f/f*<1

Thus, if the ON period of the drives is p hours, then the drives must be OFF for p/R hours.

Further, since at any one time only a subset of all drives are powered on, the effective number of drives in the system that are powered ON is R*N.

Thus, the ratio R of all drives at a shelf is also the number of drives that must be powered ON in total in each shelf. This also limits the number of drives that are used for data writing or reading as well as any other drives used for holding metadata.

There is one other constraint that must be satisfied in the power cycling that determines the ON period of p hours.

If the typical life of the drive is f hours (same as nominal MTTF), then the number of power cycling events for a drive is CSS (for contact start stops)
CSS=f/(p+p/R)

Since CSS is limited to a maximum CSSmax, for any drive
CSS<CSSmax

Thus, p must be chosen such that CSSmax is never exceeded.

FIG. 4 depicts the flowchart for establishing power cycling parameters.

Efficient Data Protection Scheme for Near Online (NOL) System.

In one embodiment, a new RAID variant is implemented in order to meet the needs of the present Power Managed system. To meet the serviceability requirement of the system, the power duty cycle R of the drives will be less than 100% and may be well below 50%. Consequently, when a data volume is written to a RAID volume in a shelf, all drives in the RAID set cannot be powered up (ON). The RAID variant disclosed herein is designed to provide the following features.

First, this scheme is designed to provide adequate parity protection. Further, it is designed to ensure that CSS thresholds imposed by serviceability needs are not violated. Further, the RAID striping parameters are designed to meet the needs of the workload patterns, the bandwidth to be supported at the rack level, and access time. The time to access the first byte must also be much better than tape or sequential media. The scheme is also designed to provide parity based data protection and disk sparing with low overhead.

There are a number of problems that have to be addressed in the data protection scheme. For instance, failure of a disk during a write (because of the increased probability of a disk failure due to the large number of drives in the system) can lead to an I/O transaction not being completed. Means to ensure data integrity and avoid loss of data during a write should therefore be designed into the scheme. Further, data protection requires RAID redundancy or parity protection. RAID operations, however, normally require all drives powered ON since data and parity are written on multiple drives. Further, Using RAID protection and disk sparing typically leads to high disk space overhead that potentially reduces effective capacity. Still further, power cycling increases the number of contact start stops (CSSs), so CSS failure rates increase, possibly by 4 times or more.

In one embodiment, there are 3 types of drives in each shelf: data and parity drives that are power cycled per schedule or by read/write activity; spare drives that are used to migrate data in the event of drive failures; and metadata drives that maintain the state and configuration of any given RAID set. A metadata drive contains metadata for all I/O operations and disk drive operational transitions (power up, power down, sparing, etc.). The data that resides on this volume is organized such that it provides information on the data on the set of disk drives, and also caches data that is to be written or read from drives that are not yet powered on. Thus, the metadata volume plays an important role in disk management, I/O performance, and fault tolerance.

The RAID variant used in the present system “serializes” writes to smallest subset of disks in the RAID set, while ensuring that CSS limits are not exceeded and that the write I/O performance does not suffer in access time and data rate.

Approach to RAID Variant

In applying data protection techniques, there are multiple states in which the set of drives and the data can reside. In one embodiment, the following states are used. Initialize—in this state, a volume has been allocated, but no data has been written to the corresponding disks, except for possible file metadata. Normal—in this state, a volume has valid data residing within the corresponding set of disk drives. This includes volumes for which I/O operations have resulted in the transferring of data. Data redundancy—in this state, a volume has been previously degraded and is in the process of restoring data redundancy throughout the volume. Sparing—in this state, a disk drive within a set is replaced.

Assumptions

When developing techniques for data protection, there are often tradeoffs made based on a technique that is selected. Two assumptions may be useful when considering tradeoffs. The first assumption is that this data storage system is not to achieve or approach the I/O performance of an enterprise online storage system. In other words, the system is not designed for high I/O transactions, but for reliability. The second assumption is that the I/O workload usage for this data storage is typically large sequential writes and medium to large sequential reads.

Set of Disk Drives Initialized

An initialized set of disk drives consist of a mapped organization of data in which a single disk drive failure will not result in a loss of data. For this technique, all disk drives are initialized to a value of 0.

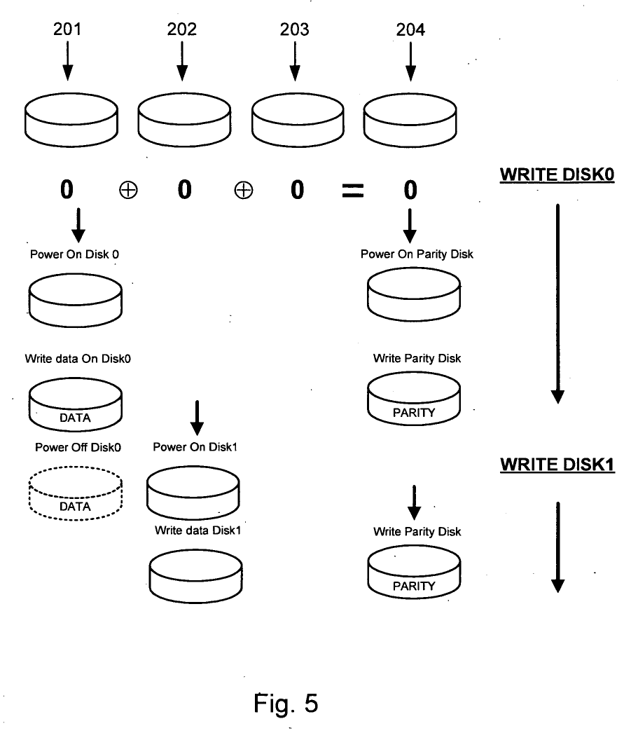

The presence of “zero-initialized” disk drives is used as the basis for creating a “rolling parity” update. For instance, referring to FIG. 5, in a set of 4 disk drives, 201-204, all drives (3 data and 1 parity) are initialized to “0”. (It should be noted that the disk drives are arranged horizontally in the figure—each vertically aligned column represents a single disk at different points in time.) The result of the XOR computation denotes the result of the content of the parity drive (0⊕0⊕0=0). If data having a value of “5” is written to the first disk, 201, then the parity written to parity disk 204 would represent a “5” (5−0⊕0=5). If the next data disk (disk 202) were written with a value of “A”, then the parity would be represented as “F” (5⊕A⊕0 =F). It should be noted that, while the parity disk contains a value equal to the XOR'ing of all three data disks, it is not necessary to power on all of the disks to generate the correct parity. Instead, the old parity (“5”) is simply XOR'ed with the newly written data (“A”) to generate the new parity (“F”). Thus, it is not necessary to XOR out the old data on disk 202.

Metadata Volume

In order to maintain the state and configuration of a given RAID set in one embodiment, there exists a “metadata volume” (MDV). This volume is a set of online, operational disk drives, which may be mirrored for fault tolerance. This volume resides within the same domain as the set of disk drives. Thus, the operating environment should provide enough power, cooling, and packaging to support this volume. This volume contains metadata that is used for I/O operations and disk drive operational transitions (power up, power down, sparing, etc.). The data that resides on this volume is organized such that copies of subsets of data representing the data on the set of disk drives.

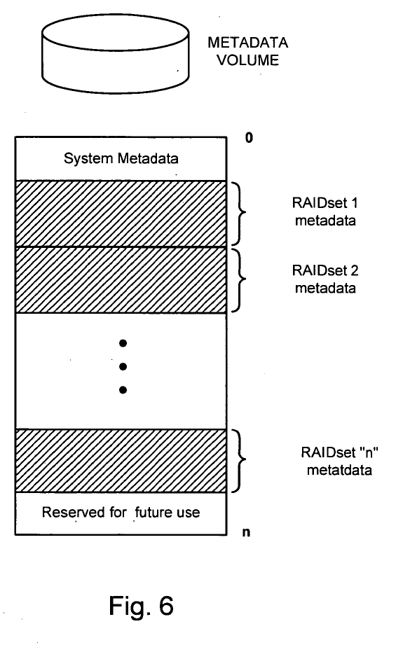

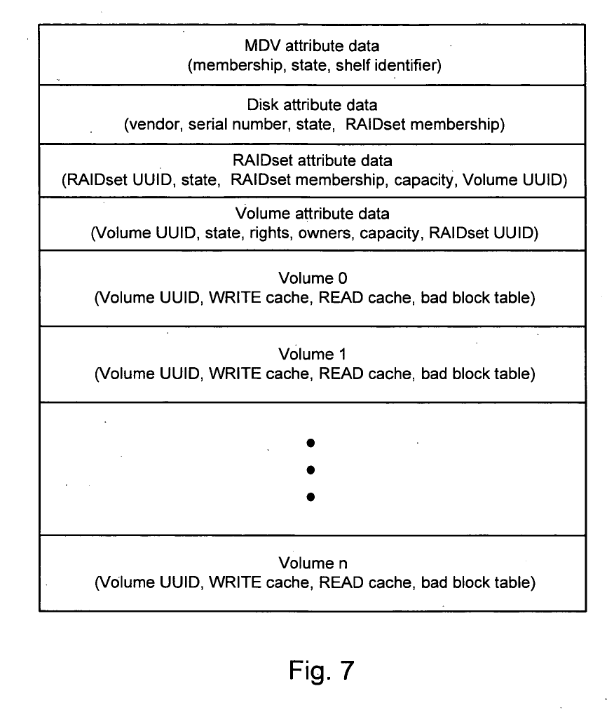

In a preferred implementation, a metadata volume is located within each shelf corresponding to metadata for all data volumes resident on the disks in the shelf. Referring to FIGS. 6 and 7, the data content of a metadata volume is illustrated. This volume contains all the metadata for the shelf, RAID, disk and enclosure. There also exists metadata for the rack controller. This metadata is used to determine the correct system configuration between the rack controller and disk shelf.

In one embodiment, the metadata volume contains shelf attributes, such as the number of total drives, drive spares, unused data, RAID set attributes and memberships, such as the RAID set set, drive attributes, such as the serial number, hardware revisions, firmware revisions, and volume cache, including read cache and write cache.

Volume Configurations

In one embodiment, the metadata volume is a set of mirrored disk drives. The minimum number of the mirrored drives in this embodiment is 2. The number of disk drives in the metadata volume can be configured to match the level of protection requested by the user. The number of disks cannot exceed the number of disk controllers. In order to provide the highest level of fault tolerance within a disk shelf, the metadata volume is mirrored across each disk controller. This eliminates the possibility of a single disk controller disabling the Shelf Controller.

In order to provide the best performance of a metadata volume, dynamic re-configuration is enabled to determine the best disk controllers for which to have the disk drives operational. Also, in the event of a metadata volume disk failure, the first unallocated disk drive within a disk shelf will be used. Thus if there are no more unallocated disk drives, the first allocated spare disk drive will be used. If there are no more disk drives available, the shelf controller will remain in a stalled state until the metadata volume has been addressed.

Volume Layout

The layout of the metadata volume is designed to provide persistent data and state of the disk shelf. This data is used for shelf configuring, RAID set configuring, volume configuring, and disk configuring. This persistent metadata is updated and utilized during all phases of the disk shelf (Initialization, Normal, Reconstructing, Service, etc.).

The metadata volume data is used to communicate status and configuration data to the rack controller. For instance, the metadata may include “health information for each disk drive (i.e., information on how long the disk drive has been in service, how many times it has been powered on and off, and other factors that may affect its reliability). If the health information for a particular disk drive indicates that the drive should be replaced, the system may begin copying the data on the disk drive to another drive in case the first drive fails, or it may simply provide a notification that the drive should be replaced at the next normal service interval. The metadata volume data also has designated volume-cache area for each of the volumes. In the event that a volume is offline, the data stored in the metadata volume for the offline volume can be used while the volume comes online. This provides, via a request from the rack controller, a window of 10-12 seconds (or whatever time is necessary to power-on the corresponding drives) during which write data is cached while the drives of the offline volume are being powered up. After the drives are powered up and the volume is online, the cached data is written to the volume.

Shelf Initializations

At power-on/reset of the disk shelf, all data is read from the metadata volume. This data is used to bring the disk shelf to an operational mode. Once the disk shelf has completed the initialization, it will wait for the rack controller to initiate the rack controller initialization process.

Volume Operations

Once the disk shelf is in an operational mode, each volume is synchronized with the metadata volume. Each volume will have its associated set of metadata on the disk drive. This is needed in the event of a disastrous metadata volume failure.

Read Cache Operations

The metadata volume has reserved space for each volume. Within the reserved space of the metadata volume resides an allocated volume read cache (VRC). This read cache is designed to alleviate the spin-up and seek time of a disk drive once initiated with power. The VRC replicates the initial portion of each volume. The size of data replicated in the VRC will depend on the performance desired and the environmental conditions. Therefore, in the event that an I/O READ request is given to an offline volume, the data can be sourced from the VRC. Care must be taken to ensure that this data is coherent and consistent with the associated volume.

Write Cache Operations

As noted above, the metadata volume has reserved space for each volume. Within the reserved space of the metadata volume resides an allocated volume write cache (VWC). This write cached is designed to alleviate the spin-up and seek time of a disk drive once initiated with power. The VWC has a portion of the initial data, e.g., 512 MB, replicated for each volume. Therefore, in the event that an I/O write request is given to an offline volume, the data can be temporarily stored in the VWC. Again, care must be taken to ensure that this data is coherent and consistent with the associated volume.

Set of Disk I/O Operations

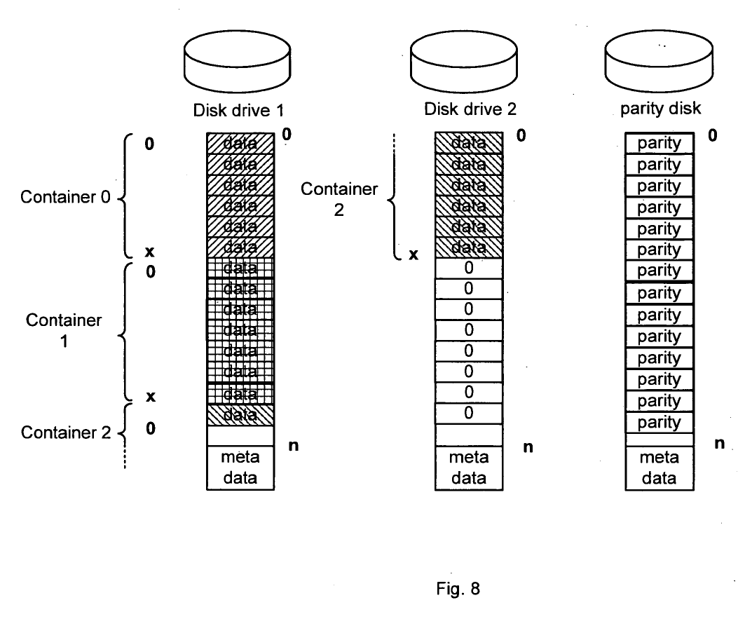

Referring to FIG. 8, a diagram illustrating the manner in which data is stored on a set of disks is shown. A set of disks are partitioned into “large contiguous” sets of data blocks, known as containers. Single or multiple disk volumes, which are presented to the storage user or server, can, represent a container. The data blocks within a container are dictated by the disk sector size, typically, 512 bytes. Each container is statically allocated and addressed from 0 to x, where x is the number of data blocks minus 1. Each container can be then divided into some number of sub-containers.

The access to each of the containers is through a level of address indirection. The container is a contiguous set of blocks that is addressed from 0 to x. As the device is accessed, the associated disk drive must be powered and operational. As an example, container 0 is fully contained within the address space of disk drive 1. Thus, when container 0 is written or read, the only disk drive that is powered on is disk drive 1.

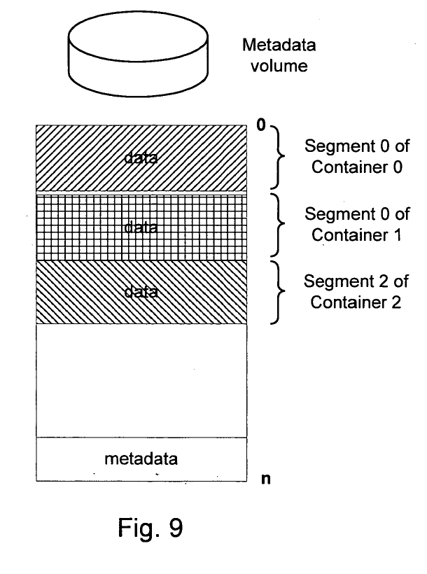

If there is a limited amount of power and cooling capacity for the system and only one disk drive can be accessed at a time, then in order to access container 2, disk drives 1 and 2 must be alternately powered, as container 2 spans both disk drives. Initially, disk drive 1 is powered. Then, disk drive 1 is powered down, and disk drive 2 is powered up. Consequently, there will be a delay for disk drive 2 to become ready for access. Thus, the access of the next set of data blocks on disk drive 2 will be delayed. This generally is not an acceptable behavior for access to a disk drive. The first segment of each disk drive and/or container is therefore cached on a separate set of active/online disk drives. In this embodiment, the data blocks for container 2 reside on the metadata volume, as illustrated in FIG. 9.

This technique, in which a transition between two disk drives is accomplished by powering down one disk drive and powering up the other disk drive, can be applied to more than just a single pair of disk drives. In the event that there is a need for higher bandwidth, the single drives described above can each be representative of a set of disk drives. This disk drive configuration could comprise RAID10 or some form of data organization that would “spread” a hot spot over many disk drives (spindles). Set of Disk Drives becoming Redundant.

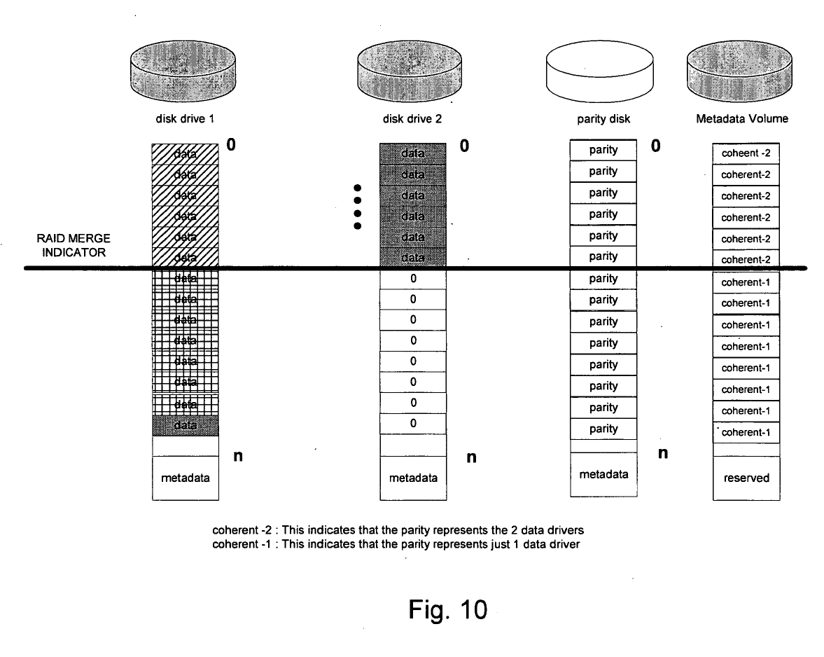

Referring to FIG. 10, a diagram illustrating the use of a pair of redundant disk drives is shown. As data is allocated to a set of disk drives, there is a need for data replication. Assuming that the replication is a form of RAID (1, 4, 5, etc.), then the process of merging must keep the data coherent. This process may be done in synchronously with each write operation, or it may be performed at a later time. Since not all disk drives are powered on at one time, there is additional housekeeping of the current status of a set of disk drives. This housekeeping comprises the information needed to regenerate data blocks, knowing exactly which set of disk drives or subset of disk drives are valid in restoring the data.

Variable RAID Set Membership

One significant benefit of the power-managed system described herein is that drives in a RAID set can be reused, even in the event of multiple disk drive failures. In conventional RAID systems, failure of more than one drive in a RAID set results in the need to abandon all of the drives in the RAID set, since data is striped or distributed across all of the drives in the RAID set. In the case of the power-managed system described herein, it is possible to reuse the remaining drives in a different RAID set or a RAID set of different size. This results in much greater utilization of the storage space in the total system.

In the event of multiple drive failures in the same RAID set, the set of member drives in the RAID set can be decreased (e.g., from six drives to four). Using the property of “zero-based” XOR parity as described above, the parity for the reduced set of drives can be calculated from the data that resides on these drives. This allows the preservation of the data on the remaining drives in the event of future drive failures. In the event that the parity drive is one of the failed drives, a new parity drive could be designated for the newly formed RAID set, and the parity information would be stored on this drive. Disk drive metadata is updated to reflect the remaining and/or new drives that now constitute the reduced or newly formed RAID set.

In one exemplary embodiment, a RAID set has five member drives, including four data drives and one parity drive. In the event of a failure of one data drive, the data can be reconstructed, either on the remaining disk drives if sufficient space is available. (If a spare is available to replace the failed drive and it is not necessary to reduce the RAID set, the data can be reconstructed on the new member drive.) In the event of a simultaneous failure of two or more data drives, the data on the non-failed drives can be retained and operations can proceed with the remaining data on the reduced RAID set, or the reduced RAID set can be re-initialized and used as a new RAID set.

This same principle can be applied to expand a set of disk drives. In other words, if it would be desirable to add a drive to a RAID set (e.g., increasing the set from four drives to five), this can also be accomplished in a manner similar to the reduction of the RAID set. In the event a RAID set would warrant an additional disk drive, the disk drive metadata would need to be updated to represent the membership of the new drive(s).

Sparing of a Set of Disk Drives

The sparing of a failed disk on of a set of disk drives is performed at both failed data block and the failed disk drive events. The sparing of failed data blocks is temporarily regenerated. Using both the metadata volume and a ‘spare’ disk drive, the process of restoring redundancy within a set of disk drives, can be more efficient and effective. This process is matched to the powering of the each of the remaining disk drives in a set of disk drives.

In the event of an exceeded threshold for failed data blocks, a spare disk drive is allocated as a candidate for replacement into the RAID set. Since only a limited number of drives can be powered on at one time, only the drive having the failed data blocks and the candidate drive are powered. At this point, only the known good data blocks are copied onto the corresponding address locations of the failed data blocks. Once all the known good blocks have been copied, the process to restore the failed blocks is initiated. Thus the entire RAID set will need to be powered on. Although the entire set of disk drives needs to powered on, it is only for the time necessary to repair the bad blocks. After all the bad blocks have been repaired, the drives are returned to a powered-off state.

In the event of a failed disk drive, all disk drives in the RAID set are powered on. The reconstruction process, discussed in the previous section, would then be initiated for the restoration of all the data on the failed disk drive.

RAIDRAIDAutomated Storage Management Features

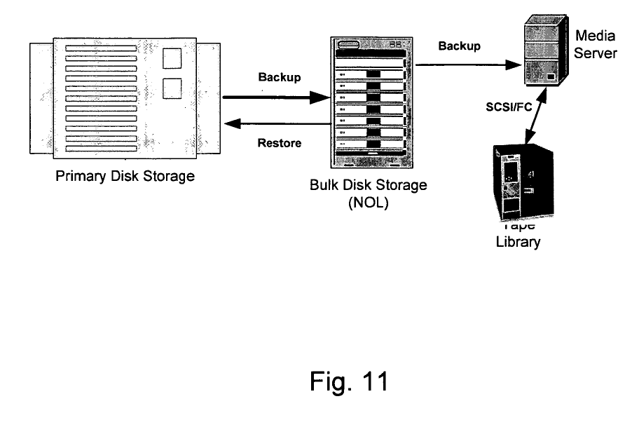

The end user of the system may use it, for example, as a disk system attached directly to a server as direct attached storage (DAS) or as shared storage in a storage area network (SAN). In FIG. 11, the system is used as the backup target to the primary storage via a direct connection and then connected via a media (backup) server to a tape library. The system may be used in other ways in other embodiments.

In this embodiment, the system presents volume images to the servers or users of the system. However, physical volumes are not directly accessible to the end users. This is because, as described earlier, through the power managed RAID, the system hides the complexity of access to physical drives, whether they are powered on or not. The controller at the rack and the shelf level isolates the logical volume from the physical volume and drives.

Given this presentation of the logical view of the disk volumes, the system can rewrite, relocate or move the logical volumes to different physical locations. This enables a number of volume-level functions that are described below. For instance, the system may provide independence from the disk drive type, capacity, data rates, etc. This allows migration to new media as they become available and when new technology is adopted. It also eliminates the device (disk) management administration required to incorporate technology obsolescence.

The system may also provide automated replication for disaster recovery. The second copy of a primary volume can be independently copied to third party storage devices over the network, either local or over wide-area. Further, the device can be another disk system, another tape system, or the like. Also, the volume could be replicated to multiple sites for simultaneously creating multiple remote or local copies.

The system may also provide automatic incremental backup to conserve media and bandwidth. Incremental and differential changes in the storage volume can be propagated to the third or later copies.

The system may also provide authentication and authorization services. Access to both the physical and logical volumes and drives can be controlled by the rack and shelf controller since it is interposed between the end user of the volumes and the physical drives.

The system may also provide automated data revitalization. Since data on disk media can degrade over time, the system controller can refresh the volume data to different drives automatically so that the data integrity is maintained. Since the controllers have information on when disks and volumes are written, they can keep track of which disk data has to be refreshed or revitalized.

The system may also provide concurrent restores: multiple restores can be conducted concurrently, possibly initiated asynchronously or via policy by the controllers in the system.

The system may also provide unique indexing of metadata within a storage volume: by keeping metadata information on the details of objects contained within a volume, such as within the metadata volume in a shelf. The metadata can be used by the controller for the rapid search of specific objects across volumes in the system.

The system may also provide other storage administration feature for the management of secondary and multiple copies of volumes, such as single-view of all data to simplify and reduce cost of managing all volume copies, automated management of the distribution of the copies of data, and auto-discovery and change detection of the primary volume that is being backed up When the system is used for creating backups.

A Preferred Implementation

Interconnect

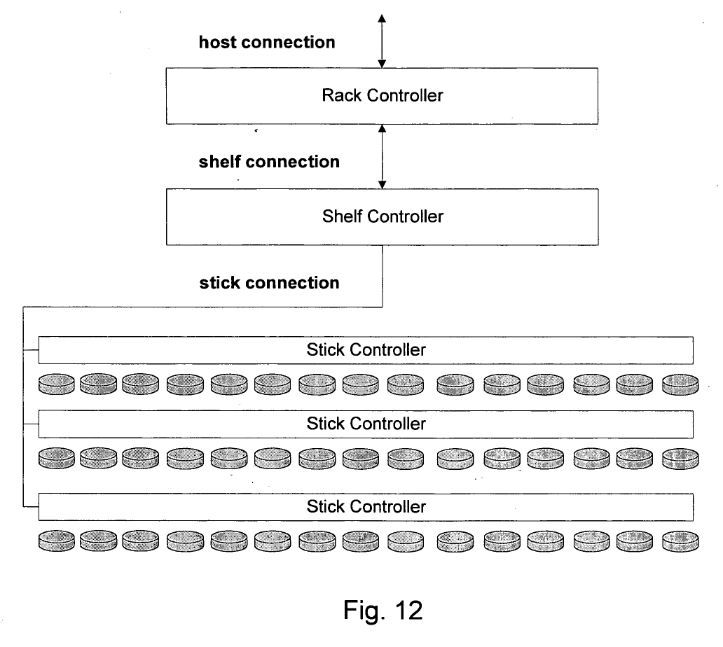

The preferred interconnect system provides a means to connect 896 disk drives, configured as 112 disks per shelf and 8 shelves per rack. The internal system interconnect is designed to provide an aggregate throughput equivalent to six 2 Gb/sec Fibre Channel interfaces (1000 MB/s read or write). The external system interface is Fibre Channel. The interconnect system is optimized for the lowest cost per disk at the required throughput. FIG. 12 shows the interconnect scheme from the host (server or end user) to the end disk drives.

The interconnect system incorporates RAID at the shelf level to provide data reliability. The RAID controller is designed to address 112 disks, some of which may be allocated to sparing. The RAID controller spans 8 sticks of 14 disks each. The RAID set should be configured to span multiple sticks to guard against loss of any single stick controller or interconnect or loss of any single disk drive.

The system interconnect from shelf to stick can be configured to provide redundancy at the stick level for improved availability.

The stick-level interconnect is composed of a stick controller (FPGA/ASIC plus SERDES), shelf controller (FPGA/ASIC plus SERDES, external processor and memory), rack controller (FPGA/ASIC plus SERDES) and associated cables, connectors, printed circuit boards, power supplies and miscellaneous components. As an option, the SERDES and/or processor functions may be integrated into an advanced FPGA (e.g., using Xilinx Virtex II Pro).

Shelf and Stick Controller

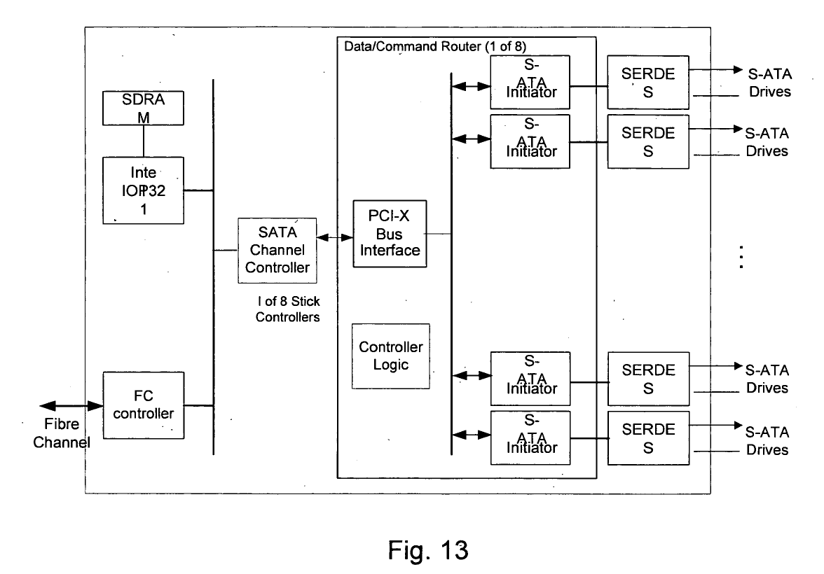

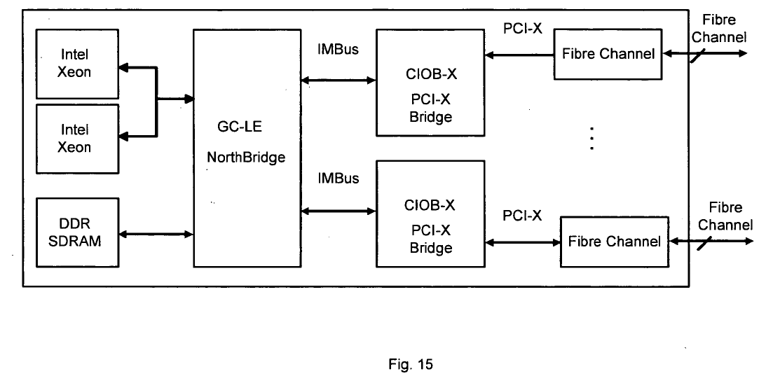

The shelf controller and the associated 8 stick controllers are shown in FIG. 13. In this implementation, the shelf controller is connected to the rack controller (FIG. 15) via Fibre Channel interconnects. It should be noted that, in other embodiments, other types of controllers and interconnects (e.g., SCSI) may be used.

The shelf controller can provide different RAID level support such as RAID 0, 1 and 5 and combinations thereof across programmable disk RAID sets accessible via eight SATA initiator ports. The RAID functions are implemented in firmware, with acceleration provided by an XOR engine and DMA engine implemented in hardware. In this case, XOR-equipped CPU Intel IOP321 is used.

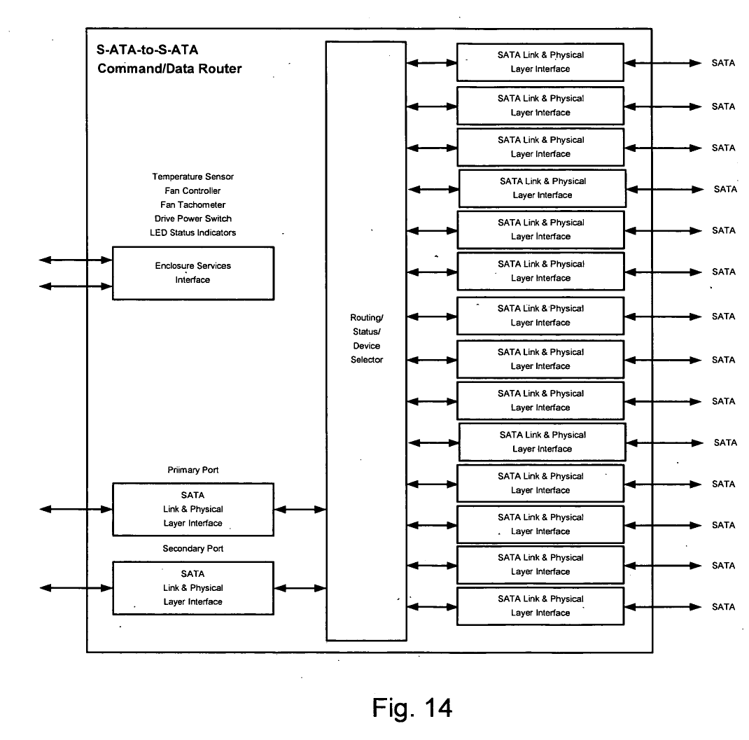

The Shelf Controller RAID control unit connects to the Stick Controller via a SATA Channel Controller over the PCI-X bus. The 8 SATA outputs of the SATA Channel Controller each connect with a stick controller data/command router device (FIG. 14). Each data/command router controls 14 SATA drives of each stick.

Rack Controller

The rack controller comprises a motherboard with a ServerWorks GC-LE chipset and four to 8 PCI-X slots. In the implementation shown in FIG. 15, the PCI-X slots are populated with dual-port or quad-port 2G Fibre Channel PCI-X target bus adapters (TBA). In other embodiments, other components, which employ other protocols, may be used. For example, in one embodiment, quad-port shelf SCSI adapters using u320 to the shelf units may be used.

Priority Based Power Management

The present invention further provides methods and systems for managing power consumption among a plurality of storage devices, such as disk drives, where all the storage devices are not powered on at the same time. Requests that require access of disk drives correspond to different types of drive access. Each request is assigned a priority level based on the type of drive access, according to which the drives are powered on or off. The requests with higher priority levels are performed before the requests with lower priority levels. The priority levels can be predetermined for each type of drive access. They can also be determined dynamically or altered, based on the usage requirements of the drives.

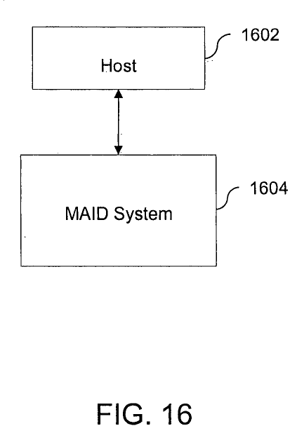

FIG. 16 is a block diagram illustrating a system suitable for data storage, in accordance with an exemplary embodiment of the present invention. The system comprises a host 1602. Examples of host 1602 include devices such as computer servers, stand-alone desktop computers, and workstations. Various applications that require storage and access of data, execute on host 1602. Such applications carry out data read/write or data transfer operations. Host 1602 is connected to a data storage system 1604 through a suitable network, such as a local area network (LAN). Host 1602 can also be directly connected to data storage system 1604. For the sake of simplicity, only one host 1602 is shown in FIG. 16. In general, there can be several hosts connected to data storage system 1604. Data storage system 1604 is a massive array of idle disks (MAID) system.

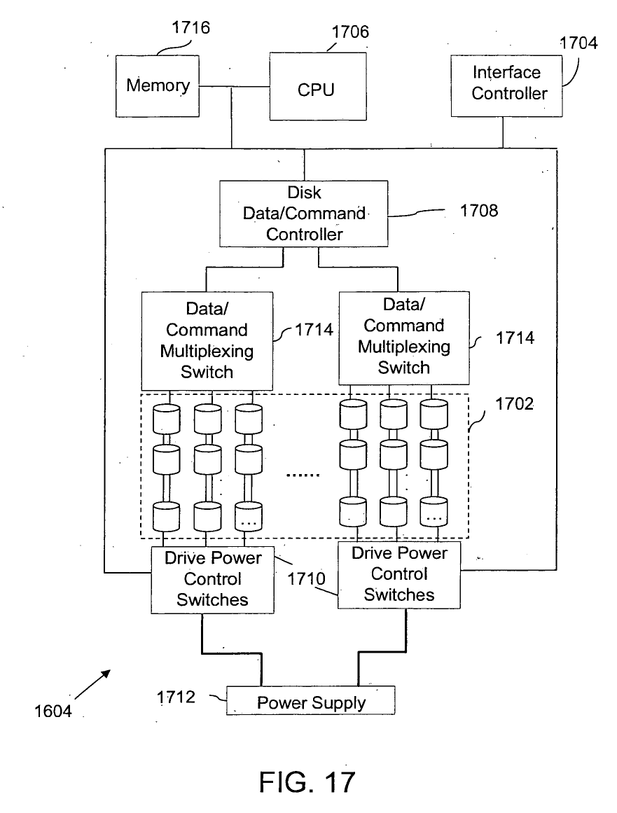

FIG. 17 is a block diagram illustrating MAID system 1604. MAID system 1604 comprises a plurality of disk drives 1702 that include disks. Plurality of disk drives 1702, store data and parity information regarding the stored data. Only a limited number of the disk drives from among plurality of disk drives 1702 are powered on at a time. In MAID system 1604, only those disk drives that are needed at a time are powered on. Disk drives are powered on when host 1602 makes a request for an operation. Disk drives can also be powered on when internal tasks are to be performed. Tasks internal to MAID system 1604 that are independent of host access also require additional drive accesses. The additional drive accesses facilitate the management of data, and maintenance of MAID system 1604. Powering on a limited number of disk drives at a time results in reduced heat generation, increase in life of disk drives, and cost reductions in power supply design and power distribution. The number of disk drives available for a particular host application depends on a power budget. The power budget defines the maximum number of disk drives that can be powered on a time. Plurality of disk drives 1702 is addressable by host 1602, to carry out host application-related operations. In an embodiment of the present invention, each disk drive from among the plurality of disk drives 1702 is individually addressable by host 1602. In another embodiment of the present invention, MAID system 1604 presents a virtual target device to host 1602, and then identifies the disk drives to be accessed. Various other embodiments of the present invention will be described with respect to the virtual target device. The virtual target device corresponds to a group of redundant array of independent/inexpensive disk (RAID) sets, according to an embodiment of the present invention. Each group of RAID sets comprises at least one RAID set, which further comprises a set of disk drives. The identification of the disk drives is based on mappings of the virtual target device presented to host 1602, to the physical disk drives from among the plurality of disk drives 1702.

MAID system 1604 further includes an interface controller 1704, a central processing unit (CPU) 1706, a disk data/command controller 1708, a plurality of drive power control switches 1710, a power supply 1712, a plurality of data/command multiplexing switches 1714, and a memory 1716. Interface controller 1704 receives data, and drive access commands for storing or retrieving data, from host 1602. Interface controller 1704 can be any computer storage device interface, such as a target SCSI controller. On receiving data from host 1602, interface controller 1704 sends it to CPU 1706. CPU 1706 controls MAID system 1604, and is responsible for controlling drive access, routing data to and from plurality of disk drives 1702, and managing power in MAID system 1604. Disk/data command controller 1708 acts as an interface between CPU and plurality of disk drives 1702. Disk/data command controller 1708 is connected to plurality of disk drives 1702 through a communication bus, such as a SATA or SCSI bus.

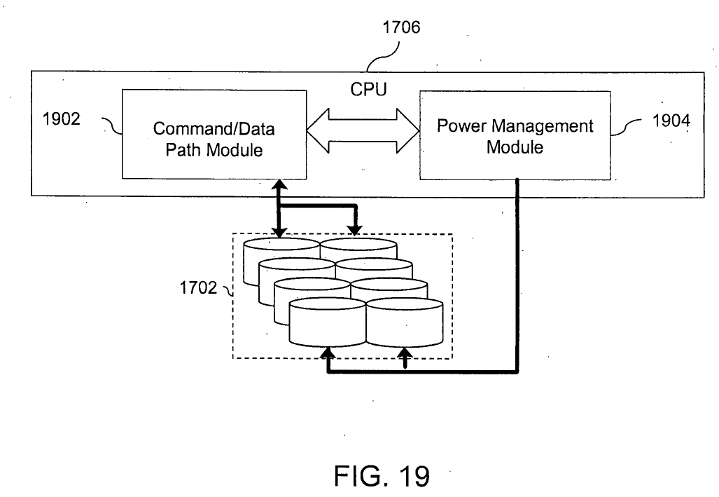

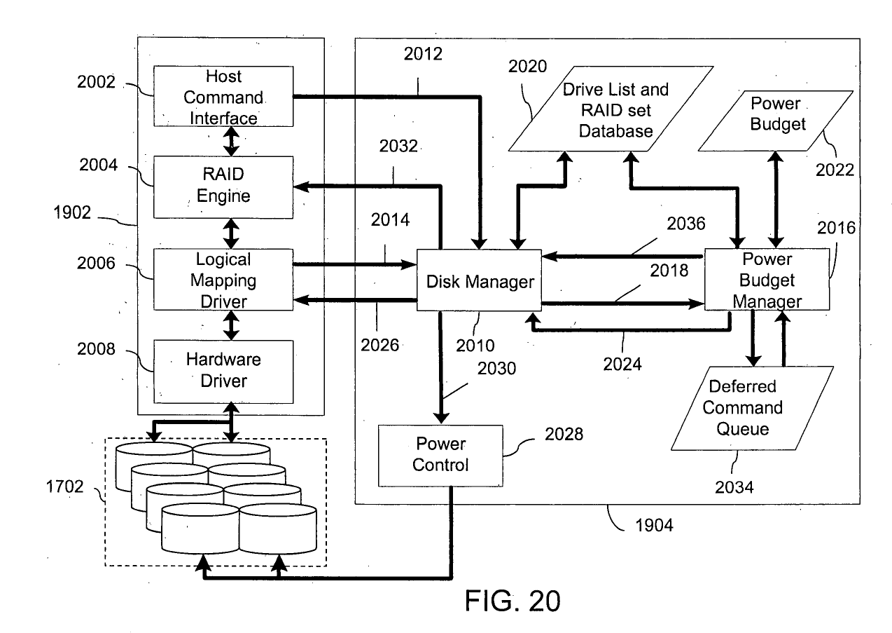

Data to be stored is sent by CPU 1706 to plurality of disk drives 1702 through disk/data command controller 1708. Further, CPU 1706 receives data from plurality of disk drives 1702 through disk/data command controller 1708. Plurality of drive power control switches 1710 control the power supplied to plurality of disk drives 1702 from power supply 1712. In an embodiment of the present invention, each drive power control switch includes a power control circuit connected to multiple field effect transistors (FETs). The power control circuit comprises multiple power control registers. On identifying the disk drives to be powered on or off, CPU 1706 writes to corresponding power control registers. The written values control the operation of the FETs that power on or off each drive individually. In an alternate embodiment of the present invention, power control can be implemented in a command/data path module. The command/data path module will be described later in conjunction with FIG. 19 and FIG. 20. In the alternate embodiment, a circuit that responds to a power-on/off command intercepts the command, before it reaches the corresponding disk drive. The circuit then operates a power control circuit, such as a FET switch. In yet another embodiment of the present invention, CPU 1706 can send power-on/off commands to the power control circuits, such as power control registers located on the disk drives directly. In this embodiment, the power control circuits directly power on or off the disk drives. Note that any suitable design or approach for controlling powering on or off the storage devices can be used.

CPU 1706 also controls plurality of data/command multiplexing switches 1714 through disk/data command controller 1708, for identifying a disk drive that receives commands based on the mappings. In an alternate embodiment of the present invention, disk/data command controller 1708 comprises a plurality of ports, so that all the disk drives can be connected to the ports. This embodiment eliminates the need for data/command multiplexing switches 1714. The mappings are stored in memory 1716 so that CPU 1706 can access them. Memory 1716 can be, for example, a random access memory (RAM). Multiple non-volatile copies of the mappings can also be stored in plurality of disk drives 1702. Other non-volatile memories, such as flash memory, can also be used to store the mappings, in accordance with another embodiment of the present invention.

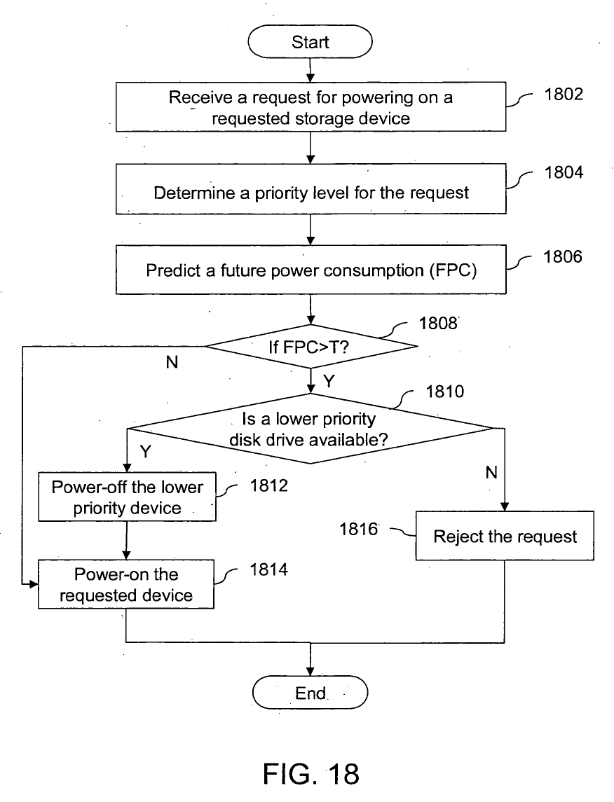

FIG. 18 is a flowchart depicting a method for managing power consumption among plurality of disk drives 1702, in accordance with an embodiment of the present invention. At step 1802, a request for powering on a disk drive or disk drives is received. After receiving the request, a priority level for the request is determined at step 1804. At step 1806, a future power consumption (FPC) for plurality of disk drives 1702 is predicted. The FPC is predicted by adding a current total power consumption of plurality of disk drives 1702 to a anticipated power consumption of the requested disk drive or drives. In accordance with an embodiment of the present invention, the current total power consumption is the total power consumption of the disk drives that are powered on at the time of receiving the request. The FPC is predicted by adding the power required to power on the requested disk drive or disk drives to the current total power consumption.

The FPC is compared with a threshold (T) at step 1808. The comparison process uses the power budget. In other words, T depends on the power budget. The power budget is calculated based on the maximum number of disk drives that can be powered on from among plurality of disk drives 1702 at any given time. In an embodiment of the present invention, this number is predetermined. T can be a fixed quantity or it can vary, depending on the power budget. In an embodiment of the present invention, T is the maximum power that can be consumed by the disk drives that are powered on at the time of carrying the request in MAID system 1604. In another embodiment of the present invention, the value of T is based on the priority level of the request, i.e., T is different for requests of different priorities. This limits the maximum number of drives that can be powered on at any time for a request of a given priority. In another embodiment of the present invention, T is defined in terms of the maximum number of drives that can be powered on.

If the FPC is found to be greater than T, then at step 1810, the availability of a disk drive carrying out a request with a priority level below the priority level determined at step 1804 is checked. If such a disk drive is powered on and available, a signal is sent to power off the disk drive. At step 1812, the lower priority disk drive is powered off. Powering off the powered-on disk drive makes sufficient power budget available for powering on the requested disk drive. Therefore, the requested disk drive is powered on at step 1814. In case, a lower priority disk drive is not available, the request is rejected due to non-availability of the power budget, at step 1816. However, if the FPC is found to be less than T (i.e., sufficient power budget is already available), the requested disk drive is powered on at step 1814, without powering off any other device that is carrying out a lower priority level request.

In an embodiment of the present invention, CPU 1706 that runs the software in MAID system 1604 implements the method described above. FIG. 19 is a block diagram illustrating software modules in MAID system 1604. CPU 1706 executes a command/data path module 1902 and a power management module 1904. Command/data path module 1902 processes requests for input/output (I/O) of data to/from plurality of disk drives 1702, referred to as I/O requests. Commands for powering on/off plurality of disk drives 1702 are processed by power management module 1904.

FIG. 20 is a block diagram illustrating the components of the software modules shown in FIG. 19. Command/data path module 1902 comprises a host command interface 2002, a RAID engine 2004, a logical mapping driver (LMD) 2006, and a hardware driver 2008. Host command interface 2002 receives and processes the commands for data storage. Host command interface 2002 sends I/O requests to RAID engine 2004, which includes a list of the disk drives in the RAID sets of MAID system 1604. RAID engine 2004 generates information such as parity, stripes data streams, and/or reconstitutes data streams to and from drives in the RAID sets. Striping a data stream refers to breaking the data stream into blocks and storing it by spreading the blocks across the multiple disk drives that are available. In another embodiment of the present invention, RAID engine 2004 is implemented in a separate hardware component of MAID system 1604, such as a logic circuit. LMD 2006 determines physical address locations of drives in the RAID sets. Hardware driver 2008 routes the data and information generated by RAID engine 2004 to and from the drives, according to the I/O requests.

Power management module 1902 comprises a disk manager (DM) 2010, a power budget manager (PBM) 2016, a power control circuit 2028, and various parameters that are stored in registers of CPU 1706. DM 2010 receives requests or power commands for powering on one or more requested disk drive from host command interface 2002 through a channel 2012. DM 2010 determines which disk drives are required for carrying out the I/O request. LMD 2006 checks the power state of a disk drive (i.e., whether the disk drive is powered on or off) with DM 2010 before sending any I/O request to the disk drive. LMD 2006 sends a drive access request to DM 2010 through a channel 2014. DM 2010 communicates with PBM 2016 to make a power command request through a channel 2018. DM 2010 also stores the drive list and RAID set database in registers 2020. The RAID set database includes the mappings of the virtual target device presented to host 1602, to the physical disk drives from among the plurality of disk drives 1702. PBM 2016 checks if the power command request can be granted. PBM 2016 predicts the FPC for plurality of disk drives 1802. This prediction is made by adding the current total power consumption of the plurality of disk drives 1802 to the anticipated power consumption of the requested disk drive. PBM 2016 compares the FPC with a threshold, T. This means that PBM 2016 checks if there is a sufficient power budget available for carrying out the I/O request. The power budget is stored in registers 2022. If sufficient power budget is available, PBM 2016 sends a signal in the form of a power authorization command for powering on the requested disk drives to DM 2010 through a channel 2024. If sufficient power budget is not available, PBM 2016 sends a power rejection command to DM 2010 through channel 2024, and the requested disk drives are not powered on. In an embodiment of the present invention, the I/O request is placed in a deferred command queue where it waits for availability of power budget. In another embodiment of the present invention, the I/O request is rejected. If sufficient power budget is available, DM 2010 powers on the requested disk drives and returns their access status to LMD 2006 through a channel 2026. LMD 2006 then communicates the access status to host command interface 2002. At this time, the requested disk drives are powered on and the virtual target device goes from a not-ready state to a ready state, indicating that it is available for carrying out the I/O request. DM 2010 sends power-on/off commands to a power control circuit 2028 through a channel 2030. Power control circuit 2028 powers the requested disk drives on or off by using these commands. In this way, DM 2010 controls the disk drives in the RAID sets.

PBM 2016 also monitors the drive power states. The monitoring operation of PBM 2016 is of a polling design. This means that PBM 2016 periodically checks on certain drive and RAID set states. The polling design is in the form of a polling loop. Some operations of PBM 2016 are also implemented in an event driven design, i.e., the operations are carried out in response to events. These operations include power requests that are generated external to PBM 2016 and have a low response time. In an embodiment of the present invention, the polling loop is implemented with variable frequencies, depending on the priority of a request. For example, the polling loop operates at a higher frequency when there are outstanding high priority requests. This ensures prompt servicing of requests. When there are no outstanding requests, the loop is set to a lower polling frequency.

In an embodiment of the present invention, the virtual target device emulates a disk array. In such a case, host 1602 implements the powering-on or powering-off of physical disk drives through explicit standard SCSI commands, such as, START/STOP UNIT. In another embodiment of the present invention, the virtual target device emulates a tape library. In this case, host 1602 implements the powering-on or powering-off of physical disk drives through standard SCSI commands, such as, LOAD/UNLOAD. An exemplary emulation of a tape library is described in U.S. patent application Ser. No. 10/996,086, titled “Method and System for Accessing a Plurality of Storage Devices”, filed on Nov. 22, 2004, which is incorporated herein by reference. In general, a command for powering on or powering off of physical disk drives by host 1602 depends on the kind of virtual target device or nature of the interface being presented to host 1602. In an alternate embodiment, host 1602 powers on the disk drives via an implied power command associated with an I/O request. In this case, an I/O request to a disk drive that is not powered on causes DM 2010 to power it on, to serve the request (assuming the power budget is available or can be made available). In addition, drives that have not been accessed for some time may be powered off.

I/O requests can be for different types of drive access or operations. I/O requests made by host 1602 are referred to as host interface user data access. Requests that are not associated with a host-requested I/O include critical RAID background rebuilds, required management access, optional management access, and remains on from prior access.

RAID engine 2004 stores metadata on one or more disk drives in plurality of disk drives 1702 and can send a request to read or write this metadata. A RAID set becomes critical when a member drive in it has failed, and has been replaced by a spare drive. In such a situation, the RAID set needs to be rebuilt to restore data redundancy, i.e., exclusive-OR (XOR) parity needs to calculated and written to a parity drive in the RAID set. XOR parity is generated by performing a XOR operation on data stored across the disk drives in the RAID set. Such rebuild requests are referred to as critical RAID background rebuilds. When the critical RAID set is powered off, but the power budget is available (i.e., there are less host-requested I/O operations than the system is capable of supporting), PBM 2016 sends a power-on command for the critical RAID set to DM 2010. On receiving this command, DM 2010 sends a rebuild command to RAID Engine 2004 through a channel 2032. However, when the power budget is not available, PBM 2016 sends a power-off command to DM 2010. DM 2010 sends a rebuild suspend command through channel 2032 to RAID engine 2004 prior to powering the member drives off. When the power budget is available again, DM 2010 sends a rebuild resume command to RAID Engine 2004 through channel 2032, to resume the rebuild.

A metadata access request can be made for a drive that is not powered on. However, the request is rejected if sufficient power budget is not available to power the drive on. RAID engine 2004 tolerates such rejections in non-critical situations. At system boot and configuration time, RAID Engine 2004 initializes each disk drive in MAID system 1604, to establish the RAID sets and their states. These mandatory drive accesses are examples of required management access. If a mandatory drive access cannot be honored due to an insufficient power budget at that time, PBM 2016 places the command (also referred to as the deferred command) in the deferred command queue. The deferred command queue is stored in registers 2034. Commands in the deferred command queue await availability of the power budget, and are executed when the power budget is available. Power budget is available when other drives that have completed their operations are shut down.

There may be other updates to the metadata, such as optional management access. These involve making and updating redundant copies of information already stored on multiple drives. PBM 2016 generates requests for additional optional management access operations to periodically check the condition of a disk drive. An example of such operations is disk aerobics, which periodically powers on disk drives that have been powered off for a long time. The disk drives are powered on to ensure that they are not getting degraded while lying unused. In an exemplary embodiment of the present invention, this time is of the order of a week. During a disk aerobics cycle, MAID system 1604 updates self-monitoring, analysis and reporting technology (SMART) data. SMART is an open standard for developing disk drives and software systems that automatically monitor the disk drive. During the disk aerobics cycle, MAID system 1604 also verifies drive integrity by performing tests, such as surface scans or storing data to and retrieving data from a scratch pad area of the disk. Scratch pad refers to storage space on a disk drive dedicated to temporary storage of data.

PBM 2016 carries out the critical RAID background rebuilds and optional management access operations and other maintenance operations by communicating maintenance power commands to DM 2010 through a channel 2036. Maintenance power commands include but are not limited to power-on and off commands during these operations.

In an embodiment of the present invention, disk drives that are turned on for read, write or maintenance operations are not powered off immediately after completion of the operations. Instead, they are left on for some time in a released state, i.e., the disk drives remain on from prior access. Therefore, a power-on command within this time excludes these disk drives. By leaving the disk drives on for some time, unnecessary switching on and off of disk drives is avoided. If power is required elsewhere in MAID system 1604, the released disk drives are the first to be powered off to make more power budget available.

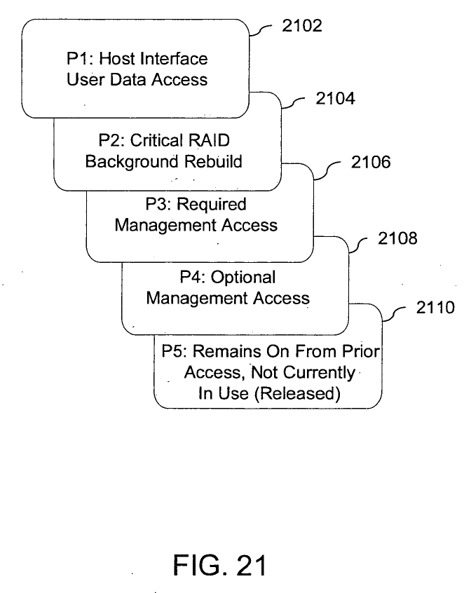

Each request described above is classified with a priority level. FIG. 21 illustrates an exemplary hierarchy of priority levels in a decreasing order of priority. At level 2102, host interface user data access is assigned the highest priority, i.e., P1. This is because host application requests are to be honored whenever possible. There are priorities that separately define operations internal to MAID system 1604. At level 2104, critical RAID background rebuilds is assigned priority P2. At level 2106, required management access is assigned priority P3. If sufficient power budget is not available at the time of making the I/O request for this type of access, these operations are placed in the deferred command queue, to wait for a time when sufficient power budget is available. Similarly, optional management access is assigned a priority P4 at level 2108. Optional operations may be rejected when there is insufficient power budget. At level 2110, remains on from prior access are assigned the lowest priority P5.

A priority level is determined for each received I/O request, which corresponds to the request for powering on a disk drive or disk drives based on the type of drive access that it makes. Generally, determining a priority level for the received request includes predetermining a priority order such as P1-P5, as depicted in FIG. 21. The priority order comprises at least two requests. The received request is compared with the predetermined priority order, and assigned a priority level accordingly. For example, if the received request is identified as a required management access on comparison with the priority order depicted in FIG. 21, it is assigned a priority level P3. In other words, the method determines the disk drives that are to be powered on and off in MAID system 1604 on the basis of the determined priorities.

When the power budget is saturated, a request for a higher priority operation will result in drives that are powered on for lower priority operations, being powered off. Further, a request for a lower priority operation will be rejected or placed in the deferred command queue, until the power budget is available. Also, if there are no lower priority operations to be preempted by the request, it is rejected or placed in the deferred command queue, to wait for the availability of the power budget.

In an embodiment of the present invention, a disk drive that is powered on and is being used for a lower-priority request can also be used for a higher priority request, if received. The disk drive is subsequently used to service the higher priority request. In other words, if a disk drive servicing a lower priority request is requested for in a higher priority request, the higher priority request is serviced without first physically powering the drive off and then on unnecessarily.

In another embodiment of the present invention, the power budget is segmented, i.e., different portions of the budget are reserved for different operations. For example, up to 90 percent of the total power budget available is reserved for P1 operations, and the last 10 percent is reserved for P2-P5 operations exclusively. Therefore, requests for a P1 operation can preempt P2-P5 requests only up to the 90 percent level reserved for it. In general, the segmentation of the power budget limits the number of drives in the virtual target device that host 1602 may request, to power on. The power budget associated with the number of drives is less than the maximum available power budget. In another example, each priority level can have access to a certain percentage of the available power budget. This segmentation ensures the running and completion of a certain number of lower priority operations along with high priority requests. In an embodiment of the present invention, the segmentation implements a hysteresis. For a given priority, there may be rapid powering on and off of disk drives as the power budget gets saturated (i.e., FPC approaches T). This can happen when new requests for powering on disk drives are received, and operations of powered-on disk drives are completed which are then powered off. This rapid powering on and off of disk drives is prevented by stalling a lower priority operation before the power budget gets saturated (i.e., FPC exceeds T), and not restarting the lower priority operation until a given amount of power budget is available (i.e., the FPC is much less than T). For example, some of the P3 operations are stopped, and the corresponding disk drives are powered off when 80% of the total power budget is consumed. Further, no new P3 operation is started until more than 50% of the power budget is available. This provides the time required for safely powering off disk drives before power budget saturation. Also, these disk drives are not powered on until adequate power budget is available. Various other combinations are also possible to ensure that there is no rapid powering on and powering off of disk drives when the current power consumption is near threshold T.

In another embodiment of the present invention, the priority order can be changed. Changing the priority order occurs while accessing one or more disk drives. For example, when a disk is being accessed for a disk restoration operation, and host 1602 makes a random read request (of higher priority), the priority order is changed and the disk restoration operation is given higher priority. In another embodiment of the present invention, changing the priority order occurs at the time of receiving the request. For example, a rebuild request may be given priority over a host 1602 made read/write request, to avoid loss of existing data from MAID system 1604. Such a situation can arise when there is more than one drives likely to fail in a RAID set. Failure can be predicted from the SMART data for the drives. The priority order can also be changed to balance the workload of MAID system 1604. The priority order may also be changed to meet a performance constraint. The performance constraint includes, but is not limited to, maintaining a balance between I/O throughput from host 1602 to MAID system 1604, in terms of data transfer rates, and data availability in terms of disk space.

Although terms such as ‘storage device,’ ‘disk drive,’ etc., are used, any type of storage unit can be adapted for use with the present invention. For example, disk drives, magnetic drives, etc., can also be used. Different present and future storage technologies can be used, such as those created with magnetic, solid-state, optical, bioelectric, nano-engineered, or other techniques.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

Storage units can be located either internally inside a computer or outside it in a separate housing that is connected to the computer. Storage units, controllers, and other components of systems discussed herein can be included at a single location or separated at different locations. Such components can be interconnected by any suitable means, such as networks, communication links, or other technology. Although specific functionality may be discussed as operating at, or residing in or with, specific places and times, in general, it can be provided at different locations and times. For example, functionality such as data protection steps can be provided at different tiers of a hierarchical controller. Any type of RAID arrangement or configuration can be used.

In the description herein, numerous specific details are provided, such as examples of components and/or methods, to provide a thorough understanding of the embodiments of the present invention. One skilled in the relevant art will recognize, however, that an embodiment of the invention can be practiced without one or more of the specific details; or with other apparatus, systems, assemblies, methods, components, materials, parts, and/or the like. In other instances, well-known structures, materials, or operations are not specifically shown or described in detail, to avoid obscuring aspects of the embodiments of the present invention.

A ‘processor’ or ‘process’ includes any human, hardware and/or software system, mechanism, or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in ‘real time,’ ‘offline,’ in a ‘batch mode,’ etc. Moreover, certain portions of processing can be performed at different times and at different locations, by different (or the same) processing systems.

Reference throughout this specification to ‘one embodiment’, ‘an embodiment’, or ‘a specific embodiment’ means that a particular feature, structure or characteristic, described in connection with the embodiment, is included in at least one embodiment of the present invention and not necessarily in all the embodiments. Therefore, the use of these phrases in various places throughout the specification does not imply that they are necessarily referring to the same embodiment. Further, the particular features, structures, or characteristics of any specific embodiment of the present invention may be combined in any suitable manner with one or more other embodiments. It is to be understood that other variations and modifications of the embodiments of the present invention, described and illustrated herein, are possible in light of the teachings herein, and are to be considered as a part of the spirit and scope of the present invention.

It will also be appreciated that one or more of the elements depicted in the drawings/figures can also be implemented in a more separated or integrated manner, or even removed or rendered as inoperable in certain cases, as is required, in accordance with a particular application. It is also within the spirit and scope of the present invention to implement a program or code that can be stored in a machine-readable medium, to permit a computer to perform any of the methods described above.

Additionally, any signal arrows in the drawings/figures should be considered only as exemplary, and not limiting, unless otherwise specifically noted. Further, the term ‘or’, as used herein, is generally intended to mean ‘and/or’ unless otherwise indicated. Combinations of the components or steps will also be considered as being noted, where terminology is foreseen as rendering unclear the ability to separate or combine.

As used in the description herein and throughout the claims that follow, ‘a’, ‘an’, and ‘the’ includes plural references unless the context clearly dictates otherwise. In addition, as used in the description herein and throughout the claims that follow, the meaning of ‘in’ includes ‘in’ and ‘on’, unless the context clearly dictates otherwise.

The foregoing description of the illustrated embodiments of the present invention, including what is described in the Abstract, is not intended to be exhaustive or limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention, in light of the foregoing description of the illustrated embodiments of the present invention, and are to be included within the spirit and scope of the present invention.

The benefits and advantages, which may be provided by the present invention, have been described above with regard to specific embodiments. These benefits and advantages, and any elements or limitations that may cause them to occur or to become more pronounced are not to be construed as critical, required, or essential features of any or all of the claims. As used herein, the terms ‘comprises,’ ‘comprising,’ or any other variations thereof, are intended to be interpreted as non-exclusively including the elements or limitations, which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for managing power consumption among a plurality of storage devices wherein less than all of the plurality of storage devices are powered-on at the same time, the method comprising:
receiving a request for powering-on a requested storage device;
determining a priority level for the request;
predicting a future power consumption by adding a current total power consumption of the plurality of storage devices to the anticipated power consumption of the requested storage device;
comparing the future power consumption against a predetermined threshold; and
if the future power consumption is greater than the threshold then sending a signal to power-off a powered-on device used for a request having a priority level below the determined priority level.

2. The method of claim 1, further comprising:
sending a signal to power-on the requested device.

3. The method of claim 2, wherein the signals are sent to a disk manager.

4. The method of claim 3, wherein the disk manager controls disks in a redundant array of independent disks.

5. The method of claim 3, wherein the disk manager controls disks in a massive array of idle disks.

6. The method of claim 1, wherein determining a priority level for the request includes:
determining if the request is for a host interface user data access.

7. The method of claim 1, wherein determining a priority level for the request includes:
determining if the request is for a critical RAID background rebuild.

8. The method of claim 1, wherein determining a priority level for the request includes:
determining if the request is for a required management access.

9. The method of claim 1, wherein determining a priority level for the request includes:
determining if the request is for an optional management access.

10. The method of claim 1, wherein determining a priority level for the request includes:
determining if the request is for a disk that is currently powered on but not currently in use.

11. The method of claim 1, wherein requests are prioritized according to the following order where first listed requests have a higher level of priority: host interface user data access; critical RAID background rebuild; required management access; optional management access; a request for a disk that is currently powered on but not currently in use.

12. The method of claim 1, wherein comparing the future power consumption against a predetermined threshold includes:
using a power budget.

13. The method of claim 12, wherein the power budget is segmented.

14. The method of claim 12, further comprising:
using a hysteresis function to determine whether the power budget will be exceeded.

15. The method of claim 1, further comprising:
setting a powered-on particular drive being used for a lower-priority request to a higher priority request; and
using the particular drive to service the higher priority request.

16. The method of claim 1, further comprising:
rejecting the received request.

17. The method of claim 1, wherein determining a priority level for the request includes:
predetermining a priority order of two or more types of requests; and
comparing the request with the predetermined priority order.

18. The method of claim 17, further comprising:
changing the priority order.

19. The method of claim 18, wherein changing the priority order occurs during accessing of one or more storage devices.

20. The method of claim 18, wherein changing the priority order occurs at a time of receiving the request.

21. The method of claim 18, wherein changing the priority order is performed to balance storage device workload.

22. The method of claim 18, wherein changing the priority order is performed to meet a performance constraint.

23. The method of claim 22, wherein the performance constraint includes balancing user I/O throughput versus maintaining data availability.

24. An apparatus for managing power consumption among a plurality of storage devices wherein less than all of the plurality of storage devices are powered-on at the same time, the apparatus comprising:
a host command interface for receiving a request for powering-on a requested storage device;
a power budget manager for determining a priority level for the request and for predicting a future power consumption by adding a current total power consumption of the plurality of storage devices to the anticipated power consumption of the requested storage device, wherein the power budget manager compares the future power consumption against a power budget; and if the future power consumption is greater than the power budget the power budget manager sends a signal to power-off a powered-on device used for a request having a priority level below the determined priority level.

25. A computer-readable medium including instructions executable by a processor for managing power consumption among a plurality of storage devices wherein less than all of the plurality of storage devices are powered-on at the same time, the computer-readable medium comprising:
one or more instructions for receiving a request for powering-on a requested storage device;
one or more instructions for determining a priority level for the request;
one or more instructions for predicting a future power consumption by adding a current total power consumption of the plurality of storage devices to the anticipated power consumption of the requested storage device; and
one or more instructions for comparing the future power consumption against a predetermined threshold; and if the future power consumption is greater than the threshold then sending a signal to power-off a powered-on device used for a request having a priority level below the determined priority level.
